(19) United States
(12) Patent Application Publication
(10) Pub. No.: US 2021/0304721 A1
(43) Pub. Date: Sep. 30, 2021

(54) BUZZER, BUZZER DEVICE AND SECURITY EQUIPMENT

(71) Applicant: GULF SECURITY TECHNOLOGY COMPANY LIMITED, Qinhuangdao, Hebei (CN)

(72) Inventors: Peng Liu, Qinhuangdao, Hebei (CN); Zhijun Li, Qinhuangdao, Hebei (CN); Zhihao Zhou, Qinhuangdao, Hebei (CN)

(21) Appl. No.: 16/973,674

(22) PCT Filed: Dec. 6, 2019
(86) PCT No.: PCT/CN2019/123494

§ 371 Date: Dec. 9, 2020

(30) Foreign Application Priority Data
Dec. 17, 2018 (CN) 201811542034.8

(51) Int. Cl. G10K 9/122; G06F 21/86

(52) U.S. Cl. CPC G10K 9/122; G08B 3/00; G06F 21/86

(57) ABSTRACT

A buzzer comprises a housing (1) and a buzzer plate (2) cooperating therewith to form a cavity (3). The cavity (3) has a sounding hole (4) in communication with the outside, and the cavity (3) is configured such that the ratio between its outer diameter (D1) and the height (H) of the buzzer is greater than 6.5 and/or the ratio between the diameter (D3) of the sounding hole (4) and the inner diameter (D2) of the cavity (3) is not greater than 0.5. A buzzer device comprising the buzzer, and a security apparatus comprising the buzzer or the buzzer device are also provided. The buzzer has advantages such as low manufacturing cost, compact structure and stable working performance. It can significantly improve the loudness of the buzzer and meet the requirements of sound pressure level for different frequency bands.

### FIELD OF THE INVENTION

The present invention relates to the technical field of sound emitting devices, and in particular to a buzzer, a buzzer device comprising the buzzer, and a security apparatus comprising the buzzer or the buzzer device.

### BACKGROUND

Various types of buzzers have been widely used in many fields such as in security industry. In particular, they constitute an important part of many signal devices. When a pre-set condition is triggered, such buzzers can be used to provide an alarm function so as to form a reliable safety mechanism. At present, although many types of buzzers have been provided to meet a variety of different application needs, they have some drawbacks and shortcomings in terms of their structural design, installation and maintenance, sound effects, working performance and manufacturing cost and so on, which can be further improved and optimized.

### SUMMARY OF THE INVENTION

In view of the foregoing, the present invention provides a buzzer, a buzzer device comprising the buzzer, and a security apparatus comprising the buzzer or the buzzer device, thereby resolving or at least alleviating one or more of the problems described above as well as problems of other aspects existing in the prior art.

Firstly, according to the first aspect of the present invention, it is provided a buzzer, which comprises a housing and a buzzer plate cooperating therewith to form a cavity, the cavity having a sounding hole in communication with the outside, characterized in that the cavity is configured such that the ratio between its outer diameter and the height of the buzzer is greater than 6.5 and/or the ratio between the diameter of the sounding hole and the inner diameter of the cavity is not greater than 0.5.

In the buzzer according to the present invention, optionally, the height of the buzzer is not more than 8 mm.

In the buzzer according to the present invention, optionally, the end surface of the cavity facing the outside is configured to be circular.

In the buzzer according to the present invention, optionally, the sounding hole is configured to be circular and disposed at the center of the end surface.

In the buzzer according to the present invention, optionally, the housing is provided with a mounting portion for mounting and positioning the buzzer.

In the buzzer according to the present invention, optionally, the buzzer plate is a piezoelectric ceramic plate, and/or the buzzer plate is arranged to be exposed to the outside.

In the buzzer according to the present invention, optionally, the buzzer plate is a piezoelectric ceramic plate, and/or the buzzer further comprises a cover member for covering the buzzer plate.

Secondly, according to the second aspect of the present invention, it is provided a buzzer device, comprising:

a buzzer according to any one of the above-described buzzers; and

a control unit configured to drive and control the buzzer plate in the buzzer to vibrate and vocalize.

In the buzzer device according to the present invention, optionally, the control unit comprises a drive circuit configured to vibrate the buzzer plate to emit a sound wave signal including one with a center frequency point of 1.4 kHz or one with a center frequency point of 2.7 kHz.

In addition, according to the third aspect of the present invention, it is provided a security apparatus, which comprises one or more buzzers according to any one of the above-described buzzers, or comprises one or more buzzer devices according to any one of the above-described buzzer devices.

From the following descriptions in combination with the drawings, one will clearly understand the principles, characteristics, features and advantages of the various technical solutions of the present invention. For example, in comparison with the prior art, the technical solutions of the invention have significantly superior technical advantages, including not only having a low manufacturing cost, compact structure and small installation space, but also having a stable working performance, especially a very high capability for energy conversion which can significantly improve the loudness of the buzzer and meet the requirements of sound pressure level for different frequency bands.

### BRIEF DESCRIPTION OF THE DRAWINGS

The technical solutions of the present invention will be further described in detail below in conjunction with the drawings and embodiments. However, it should be understood that the drawings are designed merely for illustrative purposes and are intended only to conceptually explain the configurations described herein. It is unnecessary to draw the drawings in proportion.

FIG. 1 is a schematic perspective view of a buzzer embodiment in accordance with the present invention

FIG. 2 is another schematic perspective view of the buzzer embodiment shown in FIG. 1.

FIG. 3 is a side cross-sectional view of the buzzer embodiment shown in FIG. 1.

FIG. 4 is a schematic diagram showing a comparison of the sounding hole diameter loudness test curves between the buzzer embodiment shown in FIG. 1 and two existing buzzer products.

### DETAILED DESCRIPTION OF THE INVENTION

First, it should be noted that the configurations, features, and advantages of the buzzer, the buzzer device comprising the buzzer, and the security apparatus comprising the buzzer or buzzer device according to the present invention will be described hereinafter by way of examples. None of these descriptions, however, should be construed, in any way, as limiting the scope of the invention.

Moreover, as for any single technical feature described or implied in the embodiments mentioned herein, or any single technical feature described or implied in the various figures, the present invention still allows any further combination or deletion of these technical features (or equivalents thereof) without any technical obstacles, and therefore it should be considered that more of such embodiments according to the invention are also within the scope of the disclosure contained in the application.

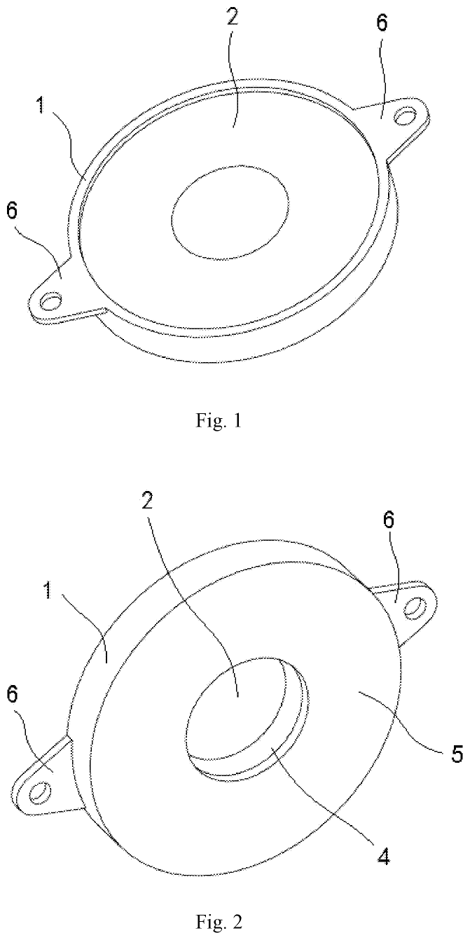

Referring to FIG. 1 to FIG. 3 together, the configuration of the buzzer according to the present invention will be described in detail below through the embodiments exemplarily shown in the accompanying drawings.

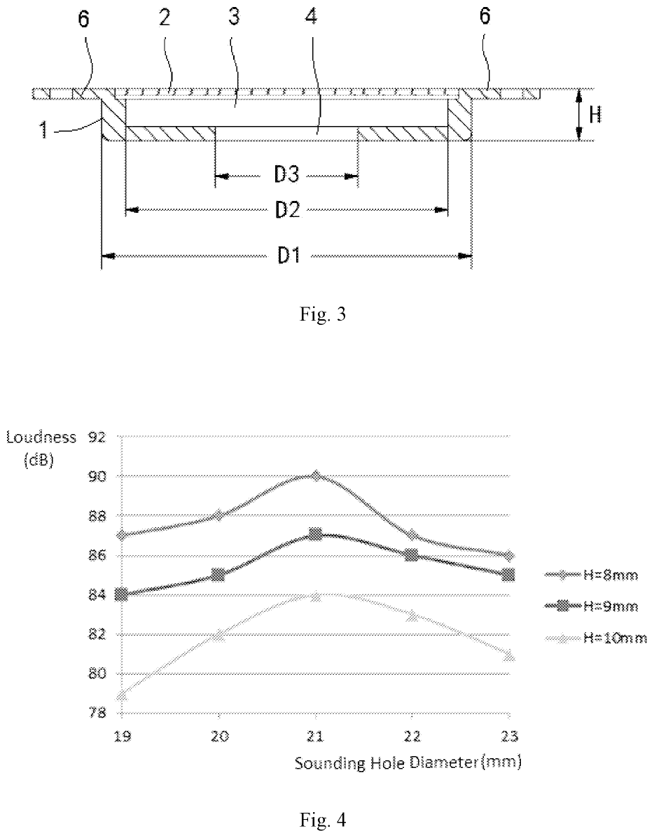

In the embodiment, the buzzer comprises a housing 1 and a buzzer plate 2. The housing 1 may be made of any suitable material such as metal (for example, iron, aluminum) or non-metal (for example, plastic), and the buzzer plate 2 may be realized using a piezoelectric buzzer plate (for example, piezoelectric ceramic plate) or the like. For instance, as shown in FIG. 3, the housing 1 and the buzzer plate 2 may be structurally designed to form a cavity 3, and a sounding hole 4 connected to the outside may be disposed on the cavity 3 so that when the buzzer plate 2 vibrates, a vibration sound wave can be generated in the cavity 3, and then transmitted to the outside through the sounding hole 4, thereby generating sound effects such as prompt reminding, safety warning, and the like.

It should be noted that although various existing buzzer products have long been commonly and widely used by the artisans in the industry, the inventors of the present application have found through extensive testing and research that the energy conversion capability of these buzzer products is mostly limited, and they especially lack the capability to achieve a greater buzzer loudness in a smaller and more compact overall size. Nevertheless, because these existing buzzers have been well known and widely used, and in particular, the artisans in the industry are so accustomed to their structure, composition, manufacturing materials and so on that they have become a standard model, the problems including those enumerated above have not been well resolved for a long time before the present invention. The innovative structural design proposed by the inventors of the invention has successfully solved the problems existing in the prior art, which confers considerable technical advantages to the buzzer in accordance with the invention. None of these can possibly be provided by the existing buzzer products.

Specifically, in the technical solutions according to the invention, the overall structure of the buzzer will be given an optimized design. It is not necessary to add any auxiliary sound diffusion structure, component or unit in the improved buzzer. Compared to the existing buzzer products, the improved buzzer not only has a compact structure and simple configuration, but also has a stable working performance. In particular, it has a significantly increased energy conversion capability and can achieve a loudness performance significantly superior than the existing buzzer products.

By way of example, as shown in FIG. 3, the buzzer may optionally be configured such that the ratio between the outer diameter D1 of the cavity 3 and the height H of the buzzer is greater than 6.5.

For another example, the buzzer may be optionally configured such that the ratio between the diameter D3 of the sounding hole 4 and the inner diameter D2 of the cavity 3 is not greater than 0.5.

As yet another example, optionally, the buzzer may be configured to have a height of not more than 8 mm, which may be achieved by, for example, optimizing the structural configuration of, for example, the housing 1, the buzzer plate 2, the cavity 3, and the like.

In addition, the buzzer plate 2 of the buzzer may be arranged to be exposed to the outside, i.e., it is not necessary to provide the buzzer with a cover member for covering the buzzer plate 2. That is to say, it is not necessary to provide the buzzer with a cover member such as a rear cover. As a result, this will be significantly different from the existing buzzer products. Omitting the above-mentioned cover member can not only save the corresponding manufacturing cost and assembling cost, but also further facilitate the buzzer to have a very compact structure. Particularly, the buzzer may be made very thin but at the same time has an excellent working performance. Of course, depending on certain requirements of actual applications, it is also contemplated that in some embodiments the buzzer plate 2 is provided with a corresponding cover member so that it is not directly exposed to the outside.

It should be appreciated that the present invention allows for the use of the above-listed or other suitable structurally optimized designs, either individually or in any combination, in order to better meet the requirements of the various possible actual applications without departing from the spirit of the invention. Using two or more structurally optimized designs in combination will be advantageous to achieve a better effect as desired for the buzzer.

By way of example, as shown in FIG. 1 and FIG. 2, the cavity 3 of the buzzer may be configured such that its end surface 5 facing outside has a circular shape. Also, the above-described sounding hole 4 may be arranged in the center of the end surface 5, and the sounding hole 4 is configured to have a circular shape. Of course, depending on the specific application needs, the invention also allows the end surface 5 and/or the sounding hole 4 of the cavity 3 to be configured in any other suitable shape. For example, they may each be configured to have a square shape or the like.

Furthermore, a mounting portion 6 may optionally be provided on the housing 1 of the buzzer so that when use, the buzzer can be mounted and positioned by such a mounting portion 6. For example, it is shown in FIG. 1 and FIG. 2 that one or more lugs may be provided on the housing 1 for use as the mounting portion 6 described above. Of course, in specific circumstances of application the invention allows the mounting portion 6 to be configured in any other suitable configuration, such as a shackle, a recess, a slot, etc.

Please refer now to FIG. 4, which shows, in comparison, the performance test curves of the buzzer embodiment shown in FIG. 1 and two existing buzzer products. The abscissa indicates the diameter of the sounding hole of the buzzer, and the ordinate indicates the loudness as measured of the above-described buzzers with different sounding hole diameters.

As shown in FIG. 4, the performance test curve of the buzzer embodiment according to the present invention is the uppermost curve among the three performance test curves in the figure. It can be seen from the figure that even when the buzzer embodiment according to the invention has a relatively thinner structure of only 8 mm, it can have loudness significantly superior than the other two existing buzzer products (one buzzer has a thickness of 9 mm and the other buzzer has a thickness of 10 mm) by utilizing the structurally optimized designs described above. In addition, extensive test results showed that the buzzer according to the invention can have a very high energy conversion capability. For example, the buzzer can achieve a sound pressure level under low power consumption (≤4 mA) that is still up to 90 dB at a distance of 3 meters in an anechoic chamber.

As described above, since the buzzers according to the present invention are remarkably superior and significantly advantageous than the prior art as described above, these buzzers are highly suitable to be used in various electromechanical products. For example, according to still another technical solution of the invention, it is provided a buzzer device which has arranged therein a buzzer designed and provided in accordance with the invention, and also arranged therein a control unit for controlling the buzzer plate in the buzzer to vibrate and vocalize.

Optionally, the above-mentioned control unit may include a drive circuit through which the buzzer plate in the buzzer can be driven to vibrate, thereby at least forming a sound wave signal that may include the following two center frequency points, that is, the buzzer may at least emit a sound wave signal with a center frequency point of 1.4 kHz or a sound wave signal with a center frequency point of 2.7 kHz, so as to better meet the practical demands for sound pressure level of different frequency bands.

In addition, according to still another technical solution of the present invention, there is also provided a security apparatus in which arranged one or more buzzers or one or more buzzer devices designed and provided according to the present invention, so as to better achieve excellent effects such as security alarms and timely reminders. In various specific applications, the buzzers or buzzer devices described above may be arranged at any suitable position in the security apparatus according to actual demands.

The buzzer, the buzzer device comprising the buzzer, and the security apparatus comprising the buzzer or the buzzer device have been described above in detail by way of example only. These examples are only for the purpose of illustrating the principles and the embodiments of the invention, but not intended to limit the scope of the invention. Various modifications and improvements can be made by those skilled in the art without departing from the spirit and scope of the invention. Therefore, all equivalent technical solutions are within the scope of the invention and are defined by the accompanying claims.

1. A buzzer, comprising a housing and a buzzer plate cooperating therewith to form a cavity, the cavity having a sounding hole in communication with the outside, characterized in that the cavity is configured such that the ratio between its outer diameter and the height of the buzzer is greater than 6.5 and/or the ratio between the diameter of the sounding hole and the inner diameter of the cavity is not greater than 0.5.

2. The buzzer according to claim 1, wherein the height of the buzzer is not more than 8 mm.

3. The buzzer according to claim 1, wherein the end surface of the cavity facing the outside is configured to be circular.

4. The buzzer according to claim 3, wherein the sounding hole is configured to be circular and disposed at the center of the end surface.

5. The buzzer according to claim 1, wherein the housing is provided with a mounting portion for mounting and positioning the buzzer.

6. The buzzer according to claim 1, wherein the buzzer plate is a piezoelectric ceramic plate, and/or the buzzer plate is arranged to be exposed to the outside.

7. The buzzer according to claim 1, wherein the buzzer plate is a piezoelectric ceramic plate, and/or the buzzer further comprises a cover member for covering the buzzer plate.

8. A buzzer device, characterized in that the buzzer device comprises:
a buzzer according to claim 1; and
a control unit configured to control the buzzer plate in the buzzer to vibrate and vocalize.

9. The buzzer device according to claim 8, wherein the control unit comprises a drive circuit configured to vibrate the buzzer plate to emit a sound wave signal including one with a center frequency point of 1.4 kHz or one with a center frequency point of 2.7 kHz.

10. A security apparatus, characterized in that the security apparatus comprises one or more buzzers according to claim 1.

11. A security apparatus, characterized in that the security apparatus comprises one or more buzzer devices according to claim 8.
